(19) United States
(12) Patent Application Publication
(10) Pub. No.: US 2012/0163284 A1
(43) Pub. Date: Jun. 28, 2012

(54) Method, Apparatus, System and Related Computer Program Product for Relay-Sensitive Routing

(75) Inventor: Ari Hottinen, Espoo (FI)

(73) Assignee: NOKIA CORPORATION, Espoo (FI)

(21) Appl. No.: 13/378,359

(22) PCT Filed: Jul. 2, 2009
(86) PCT No.: PCT/EP09/58346

§ 371 Date: Mar. 14, 2012

(51) Int. Cl. H04B 7/14; H04W 4/00

(52) U.S. Cl. 370/315

(57) ABSTRACT

It is disclosed a method (and related apparatus) comprising indexing at least two source streams from at least one source entities and/or at least two sink streams to at least two sink entities, and determining that at least one signal from the at least one source entity to the at least two sink entities is to be relayed based on a result of the indexing.

### FIELD OF THE INVENTION

Examples of the present invention relate to relay-sensitive routing. More specifically, the examples of the present invention relate to a method, an apparatus, a system, and a related computer program product for relay-sensitive routing. The examples of the present invention may be applicable e.g. to use of a relay entity in a multi-hop network.

### BACKGROUND

Multi-hop or relay entities have been studied e.g. for long term evolution (LTE), worldwide interoperability for microwave access (WiMAX) and for other networks including shorter) range communication systems such as wireless local area network (WLAN) or ultra-wide band (UWB).

A communication network may comprise at least two source entities, at least one relay entity, and at least one sink entity. The signal arrives at least partially to the sink entities (e.g. UE, device, or terminal in downlink, to network node in uplink, of between two network nodes or devices) via a (multi-antenna) relay. The signal coming to the sink entities can be transmitted from one of the source entities. Such a communication network may e.g. be a cellular network where the network can route user data to multiple (or to selected) access points (base stations, Node B's), or a mesh network where the route a given data should follow is to be determined by a suitable routing method, or a collection of access points (or wireless routers). In wireless mesh networks, the source entities may be two wireless units that receive information from another network entity. The network nodes may be access points of an institute of electrical and electronics engineers (IEEE) 802.11/16 system, for example, or similar entities of third generation (3G) or fourth generation (4G) networks.

There have been approaches related to the use relays in wireless networks. For example, it is well-known that relay weights can be optimized for improved service of signal quality. More particularly, there has been discussed a particular relaying scheme, e.g. multiuser zero-forcing (MUZF) relaying, where each relay has one receive and transmit antenna and one weighting coefficient per receive (or transmit) antenna. With sufficient number of relays, and appropriately selected weighting coefficients, multiple source signals can be fully decoupled for the sink entity. That is, given a sufficient number of relays, and appropriate weighting coefficients, the multiple input multiple output (MIMO) relay channel is orthogonalized by the relay entities performing channel-aware virtual scattering. The weighting coefficients can be also computed so that effective MIMO channel is not completely orthogonalized.

The above relaying scheme, given here just as an example, can be summarized by the following model:

1. A source entity s transmits a signal x(s); s=1; . . . ; S. These are collected to a vector x, and they arrive at relay through an R×S MIMO channel F with total transmit power P.

2. Each relay multiplies its respective received signal with an antenna specific complex weighting coefficient wᵣ. These coefficients are collected in a diagonal matrix

Λ₂=diag(w₁, . . . , w_{R}) (1)

3. The N_{d}×R MIMO channel from the relay to each sink is given by H. For example, in a two-hop amplify-and-forward (AF) network, the sink receives

y=HΛ₂Fx+HΛ₂nᵣ+n_{d} (2)

where the elements of complex Gaussian vector nᵣ designate noise with variance σᵣ² at each relay receive antenna, and elements of n_{d} designate complex Gaussian noise with variance σ_{d}² at each sink antenna.

4. The mutual information with independent and identically distributed (i.i.d.) Gaussian sources (in terms of bits-per-channel-use (bpcu)) for the signal model (2) is

α= 1/2 log₂ det(I+PHΛ₂FF⁺Λ₂⁺H⁺Rₙₙ⁻¹) (3)

where (·)⁺ denotes the adjunct or complementary matrix (conjugate transpose) of (·), and where the noise correlation matrix is

Rₙₙ=(σ_{d}²I+σᵣ²HΛ₂Λ₂⁺H⁺) (4)

Factor ½ in equation (3) is due to two-hop relaying, assuming, for simplicity that equal number channel resources (time slots) are used both first and second hop respectively.

In consideration of the above, without limiting the invention for the above, according to the examples of the present invention, a method, an apparatus, a system and a related computer program product for relay-sensitive routing are provided.

In this connection, the examples of the present invention enable one or more of the following:

Examples 1 and 2 (first and second examples to be described herein below) enable determining which signal is transmitted from which source or determining to which sink are different signals relayed;

Examples 1 and 2 address the routing problem instead of providing the given network structure and given source and sink pairs;

At least example 1 enables, compared to the situation with fixed source entities, more than a 50 percent capacity increase at a low signal-to-noise-ratio (SNR) regime and still significant gain at a high SNR.

### BRIEF DESCRIPTION OF THE DRAWINGS

The examples of the present invention are described herein below with reference to the accompanying drawings, in which:

FIG. 1A shows the method for relay-sensitive routing according to the first and second examples of the present invention on a chip/processor level;

FIG. 1B shows the apparatus for relay-sensitive routing according to the first and second examples of the present invention on the chip/processor level;

FIG. 2A shows the method for relay-sensitive routing according to the first and second examples of the present invention on an entity level;

FIG. 2B shows the apparatus for relay-sensitive routing according to the first and second examples of the present invention on the entity level;

FIG. 3A shows the method for relay-sensitive routing according to the first and second examples of the present invention on a network/system level;

FIG. 3B shows the apparatus for relay-sensitive routing according to the first and second examples of the present invention on the network/system level; and

FIG. 4 shows a performance gain, i.e. mutual information (bits per channel use) at a sink entity for the method/apparatus according to the first example of the present invention divided by mutual information with fixed sources. Depicted are 3 source-sink pairs with a single 5-antenna MUZF relay entity in between.

### DETAILED DESCRIPTION OF THE EXAMPLES OF THE PRESENT INVENTION

The examples of the present invention are described herein below by way of example with reference to the accompanying drawings.

It is to be noted that for this description, the terms “apparatus, circuitry and hardware (HW)/firmware/software (SW); decode and forward relay, single-antenna relay and multi-antenna relay e.g. with beamforming in input/output (e.g. fixed beams or digital beamforming); determination of indexing and for signaling related decisions e.g. source and/or sink indices for given signal streams, relaying signaling or channel information or related information e.g. to a network e.g. for computing decision metrics (such as performing measurements of signal model parameters), and/or; throughput, capacity estimate, signal-to-noise ratio and channel quality indicator; channel information, noise power and pilot channels; wireless local area network; long term evolution; and handover of at least one user from a first base station to a second base station” are examples for “entity; relaying entity; signaling scheme; performance measure; available information; first access technology; second access technology; and routing”, respectively, without restricting the latter-named terms to the special technical or implementation details imposed to the first-named terms. Further, it is to be noted that the first and second examples described herein below occasionally refer to “orthogonal relaying”, which is, however, only an example for any relay operation affecting e.g. optimality of routing and/or indexing described herein below.

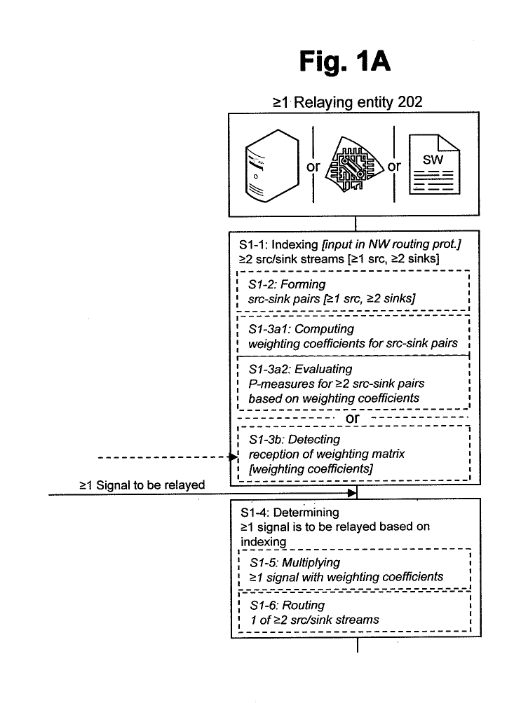

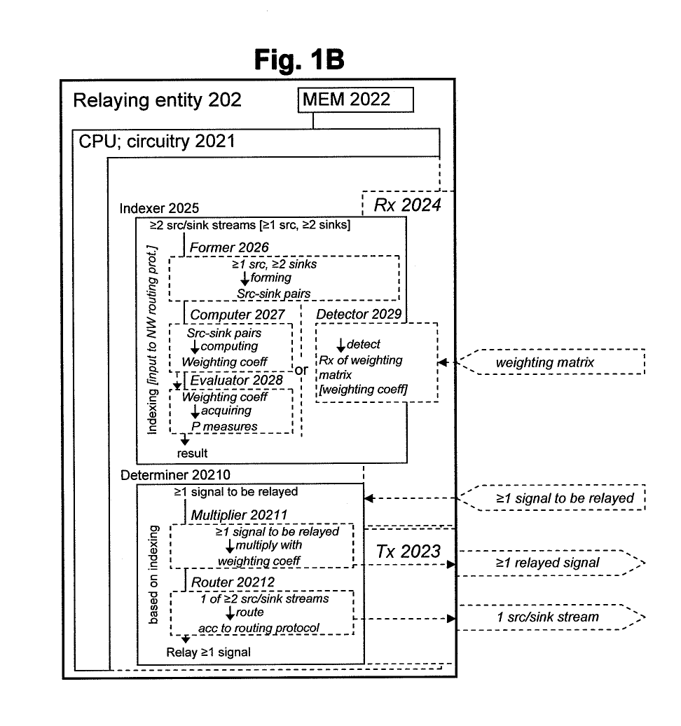

In FIGS. 1A and 1B (chip/processor level), a (first example) or at least two (second examples) relaying entity/entities 202 according to the first and second examples of the present invention is/are shown. In

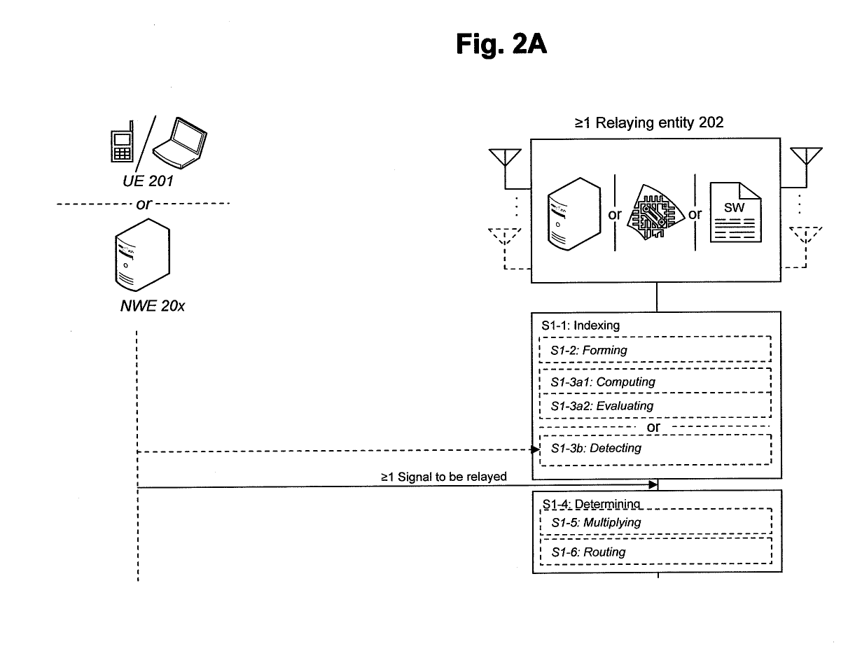

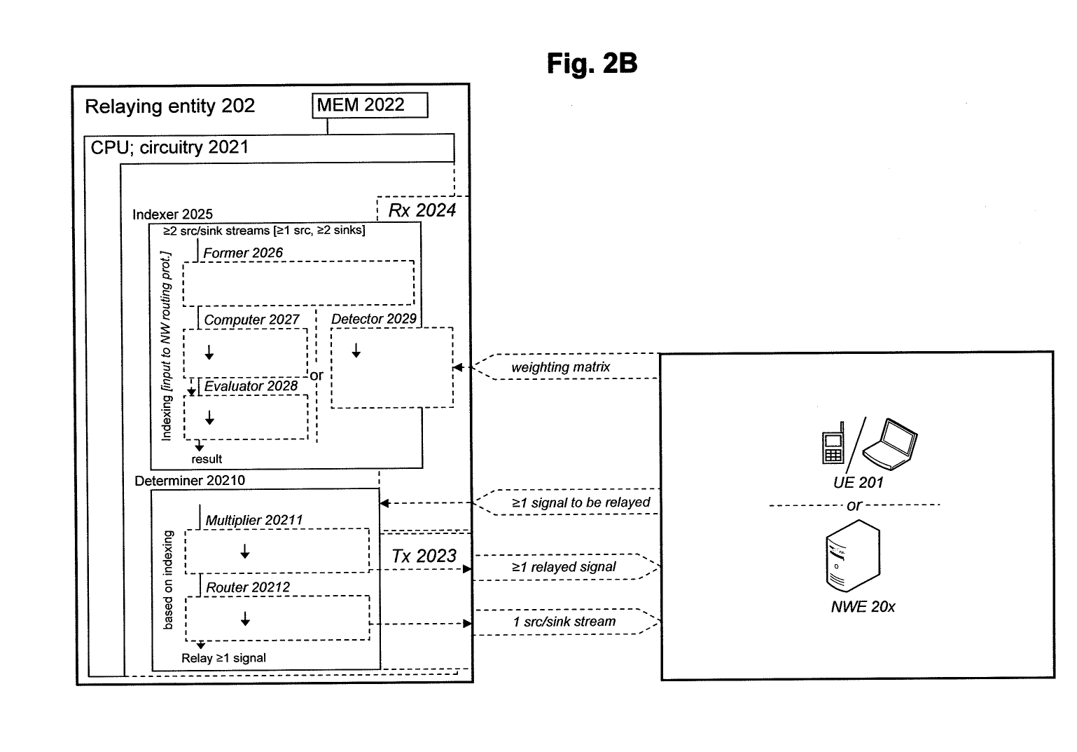

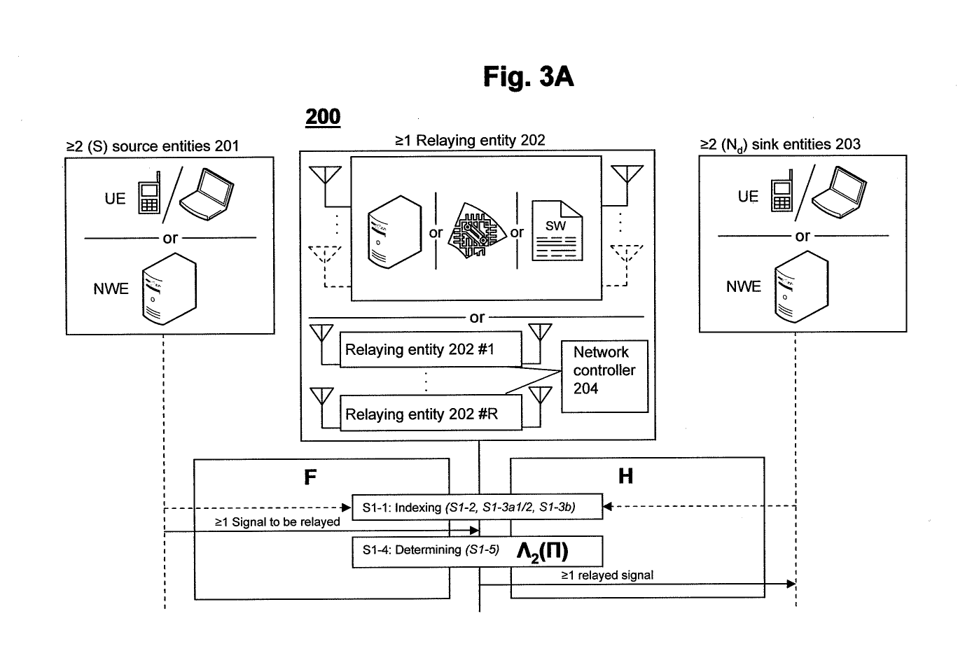

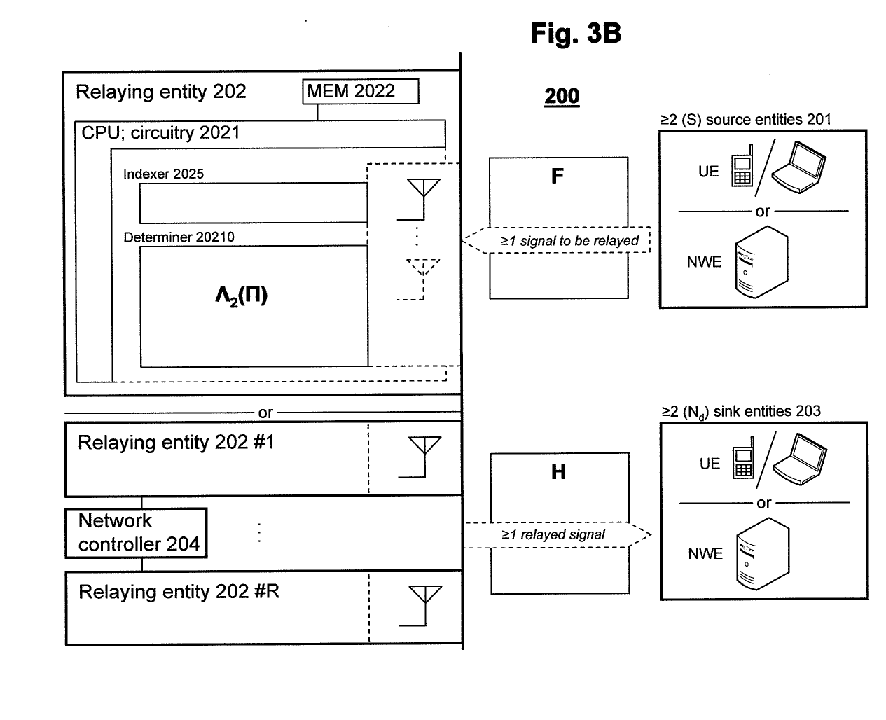

FIGS. 2A and 2B (entity level), the relaying entity 202 is shown in context with a user equipment (UE) 201 and a network element (NWE) 20x. Finally, in FIGS. 3A and 3B (network/system level), a communication system 200 may comprise the UE 201 or NWE 20x as source entities 201, the one relaying entity 202 having transmission rank R (first example) or more than the one relaying entity 202 having transmission rank R in sum total (second example), a UE or NWE as sink entities 203, and a network controller 204 (second example).

FIGS. 1A, 2A and 3A show the method for relay-sensitive routing according to the first and second examples of the present invention on the chip/processors level, entity level and network/system level, respectively. Signaling between elements is indicated in horizontal direction, while time aspects between signaling are reflected in the vertical arrangement of the signaling sequence as well as in the sequence numbers. It is to be noted that the time aspects indicated in FIGS. 1A, 2A and 3A do not necessarily restrict any one of the method steps shown to the step sequence outlined. This applies in particular to method steps that are functionally disjunctive with each other, for example reception of weighting matrix and reception of at least one signal to be relayed. For ease of description, means or portions which may provide main functionalities are depicted with solid functional blocks or arrows and/or a normal font, while means or portions which may provide optional functions are depicted with dashed functional blocks or arrows and/or an italic font.

As shown in FIGS. 1A, 2A and 3A, in step S1-1, e.g. the or the at least one relaying entity 202 may be caused at least to perform indexing at least two source streams from at least one source entity and/or at least two sink streams from at least two sink entities.

Further, in an optional step S1-2, e.g. the indexing, to the performing of which the or the at least one relaying entity 202 is caused to, may further comprise forming of source-sink pairs based on the at least one source entity and the at least two sink entities.

Still further, in optional steps S1-3a1 and S1-3a2, e.g. the indexing, to the performing of which the or the at least one relaying entity 202 is caused to, may further comprise computing weighting coefficients for source-sink pairs, and evaluating performance measures for at least two source-sink pairs using the computed weighting coefficients. In this case, e.g. the computing, to the performing of which the or the at least one relaying entity 202 is caused to, may be based on available information such that the weighting coefficients producing the highest mutual information are selected.

Alternatively to the above acquiring and computing, in an optional step S1-3b, e.g. the indexing, to the performing of which the or the at least one relaying entity 202 is caused to, may further comprise detecting that a weighting matrix comprising the weighting coefficients is to be received.

Then, in step S1-4, e.g. the or the at least one relaying entity 202 may be caused at least to perform determining that at least one signal from the at least two source entities to the at least two sink entities is to be relayed based on a result of the indexing.

Further, in an optional step S1-5, e.g. the determining, to the performing of which the or the at least one relaying entity 202 is caused to, may further comprise multiplying the at least one signal to be relayed with the weighting coefficients. Still further, the indexing, to the performing of which the or the at least one relaying entity 202 is caused to, may be used as an input for a network routing protocol and in an optional step S1-6, e.g. the determining, to the performing of which the or the at least one relaying entity 202 is caused to, may further comprise routing one of the at least two source streams and/or the at least two sink streams.

As shown in FIG. 2A, in addition to all of the above features, a transfer function y′ of the or the at least one relaying entity 202 with a transmission rank R may have the form:

y′=H·Λ₂·F·Π·x,

wherein:

x denotes a source signal x(s), s=1, . . . , S from S source entities,

Π denotes an S×S permutation matrix modeling the indexing of the source entities,

F denotes a R×S relay input channel between the source entities and the at least one relaying entity,

Λ₂ denotes a diagonal matrix of weighting coefficients, and

H denotes a N_{d}×R channel between the at least one relaying entity and the sink entities, N_{d} being the number of sink entities.

As shown in FIG. 3A, as an alternative to the above transfer function (or signal model) function, a function y of the network or system 200, the network or system comprising S source entities, the or the at least one relaying entity 202 with a transmission rank R and N_{d} sink entities, may have the form:

y=H·Λ₂·F·Π·x+H·Λ₂·nᵣ+n_{d},

wherein:

x denotes a source signal x(s), s=1, . . . , S,

Π denotes an S×S permutation matrix modeling the indexing of the source entities,

F denotes a R×S relay input channel between the source entities and the at least one relaying entity,

Λ₂ denotes a diagonal matrix of weighting coefficients,

H denotes a N_{d}×R channel between the at least one relaying entity and the sink entities, N_{d} being the number of sink entities,

nᵣ denotes noise at a receiving end of the at least one relaying entity, and

n_{d} denotes noise at a receiving end of the sink entities.

In addition to the above function or network/system function, the relay input channel F may be based on a first access technology, while the channel H may be based on a second access technology different from the first access technology. Moreover, the at least one signal to be relayed may be changed in terms of one of carrier frequency and multiple access scheme. Still further, the at least one signal to be relayed may be based on orthogonal multiple access scheme. Finally, the sink entities may be one selected from the sink entities.

FIGS. 1B, 2B and 3B show the apparatus (e.g. relaying entity 202) for relay-sensitive routing according to the first and second examples of the present invention. Within FIGS. 1B, 2B and 3B, for ease of description, means or portions which may provide main functionalities are depicted with solid functional blocks or arrows and/or a normal font, while means or portions which may provide optional functions are depicted with dashed functional blocks or arrows and/or an italic font.

As shown in FIG. 1B (chip/processor level), the relaying entity 202 may comprise a CPU (or circuitry or single-core/multi-core processor) 2021, a memory (or memories) 2022, an optional transmitter (or means for transmitting) 2023, an optional receiver (or means for receiving) 2024, an indexer (or means for indexing) 2025, an optional former (or means for forming) 2026, an optional computer (or means for computing) 2027, an optional evaluator (or means for evaluating) 2028, an optional detector (or means for detecting) 2029, a determiner (or means for determining) 20210, an optional multiplier (or means for multiplying) 20211 and an optional router (or means for routing) 20212.

As indicated by the dashed extensions of the functional block of the CPU 2021, the means for indexing 2025, the means for forming 2026, the means for computing 2027, the means for evaluating 2028, the means for detecting 2029, the means for determining 20210, the means for multiplying 20211 and the means for routing 20212 of the relaying entity 202 may be functionalities/software/firmware etc. running on the CPU 2021 of the relaying entity 202, or may alternatively be separate functional entities/circuitries or means.

The CPU 20x1 (wherein x=2) may be configured, for example by software/firmware residing in the memory (or memories) 20x2, to process various data inputs and to control the functions of the memories 20x2, the means for transmitting 202x3 and the means for receiving 20x4 (and the means for indexing 2025, the means for forming 2026, the means for computing 2027, the means for evaluating 2028, the means for detecting 2029, the means for determining 20210, the means for multiplying 20211 and the means for routing 20212 of the relaying entity 202). The memory/memories 20x2 may serve e.g. for storing code means/software/firmware etc. for carrying out e.g. the method according to the examples of the present invention, when run e.g. on the CPU 20x1. It is to be noted that the means for transmitting 20x3 and the means for receiving 20x4 may alternatively be provided as respective integral transceivers. It is further to be noted that the transmitters/receivers may be implemented i) as physical transmitters/receivers for transceiving e.g. via the air interface (e.g. between the relaying entity 202 and a UE as source/sink entity), ii) as routing entities e.g. for transmitting/receiving data packets e.g. in a PS (packet switching) network (e.g. between the relaying entity 202 and another NWE 20x when disposed as separate network entities), iii) as functionalities for writing/reading information into/from a given memory area (e.g. in case of shared/common CPUs or memories e.g. of the relaying entity 202 and another NWE 20x when disposed as an integral network entity), or iv) as any suitable combination of i) to iii).

As shown in FIGS. 1B, 2B and 3B, e.g. the means for indexing 2025 may cause the or the at least one relaying entity at least to perform indexing at least two source streams from at least one source entity and/or at least two sink streams to at least two sink entities.

Further, e.g. the means for indexing 2025 may further comprise means for forming 2026 which may cause the or the at least one relaying entity 202 at least to perform forming of source-sink pairs based on the at least one source entity and the at least two sink entities.

Still further, e.g. the means for indexing 2025 may further comprise means for computing 2027 which may cause the or the at least one relaying entity 202 at least to perform computing of weighting coefficients for source-sink pairs, and means for evaluating 2028 which may cause the or the at least one relaying entity 202 at least to perform evaluating of performance measures for at least two source-sink pairs using the computed weighting coefficients. In this case, e.g. the means for computing 2028 may cause the or the at least one relaying entity 202 at least to perform computing based on available information such that the weighting coefficients producing the highest mutual information are selected.

Alternatively to the above operations of the means for acquiring 2027 and means for computing 2028, e.g. the means for indexing 2025 may further comprise means for detecting 2029 which may cause the or the at least one relaying entity 202 at least to perform detecting that a weighting matrix comprising the weighting coefficients is to be received.

Then, e.g. the means for determining 20210 may cause the or the at least one relaying entity 202 at least to perform determining that at least one signal from the at least two source entities to the at least two sink entities is to be relayed based on a result of the indexing.

Further, e.g. the means for determining 20210 may further comprise means for multiplying 20211 which may cause the or the at least one relaying entity 202 at least to perform multiplying the at least one signal to be relayed with the weighting coefficients. Still further, e.g. the means for indexing 2025 may cause the or the at least one relaying entity 202 to perform indexing being used as an input for a network routing protocol, and e.g. the means for determining 20210 may further comprise means for routing 20212 which may cause the or the at least one relaying entity 202 to perform routing one of the at least two source streams and/or the at least two sink streams.

As shown in FIG. 2B, in addition to all of the above features, a transfer function y′ of the or the at least one relaying entity 202 with a transmission rank R may have the form:

y′=H·Λ₂·F·Π·x,

wherein:

x denotes a source signal x(s), s=1, . . . , S from S source entities,

Π denotes an S×S permutation matrix modeling the indexing of the source entities,

F denotes a R×S relay input channel between the source entities and the at least one relaying entity,

Λ₂ denotes a diagonal matrix of weighting coefficients, and

H denotes a N_{d}×R channel between the at least one relaying entity and the sink entities, N_{d} being the number of sink entities.

In addition to the above transfer function, the relay input channel F may be based on a first access technology, while the channel H may be based on a second access technology different from the first access technology. Moreover, the at least one signal to be relayed may be changed in terms of one of carrier frequency and multiple access scheme. Still further, the at least one signal to be relayed may be based on orthogonal multiple access scheme. Finally, the sink entities may be one selected from the sink entities.

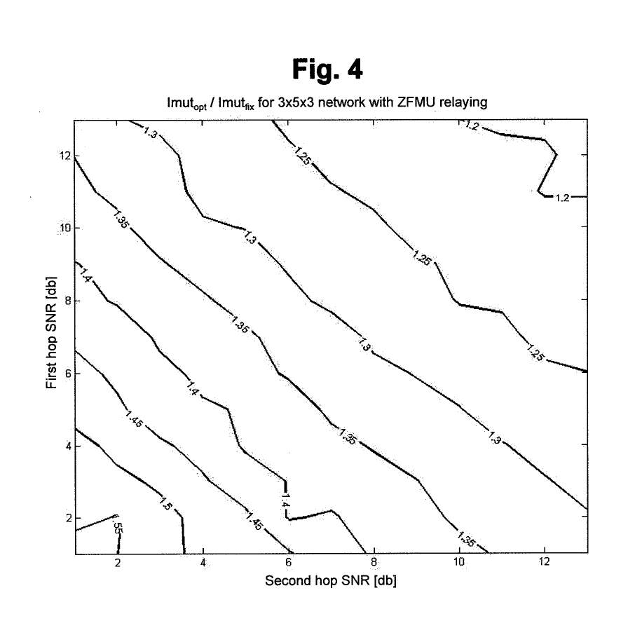

FIG. 4 shows a performance gain for different signal-to-noise ratios in an i.i.d. Rayleigh fading MIMO relay channel. Mutual information at the sink entity is computed for multiuser ZF (MUZF) beamforming, both for without hypothetical permutation matrix at transmitter (the relay entity or entities 202 may compute the permutation matrix internally having knowledge of H and F e.g. via pilot channels), and with the permutation matrix according to the first and second examples of the present invention. There are four source entities and thus 24 possible permutation matrices. The relay entity applies each of these (and subsequently, the weighting matrix) and selects the permutation that gives highest mutual information. The performance is computed for three source system with either 5 relay antennas.

Furthermore, at least one of, or more of the above-described means for indexing 2025, means for determining 20210, means for forming 2026, means for computing 2027, means for evaluating 2028, means for multiplying 20211, means for detecting 2029, means for routing 20212 as well as the relaying entity 202, or the respective functionalities carried out, may be implemented as a chipset, module, subassembly or circuitry.

Finally, the examples of present invention also relate to a system which may comprise S source entities, the at least one relaying entity 2012 according to the above-described first and second examples of the present invention, a network controller 204 for controlling the at least one relaying entity (second example) and N_{d} sink entities.

As shown in FIG. 3B, a function y of the above-defined system 200, the system comprising S source entities, the or the at least one relaying entity 202 with a transmission rank R and N_{d} sink entities, may have the form:

y=H·Λ₂·FΠ·x+H·Λ₂·nᵣ+n_{d},

wherein:

x denotes a source signal x(s), s=1, . . . , S,

Λ denotes an S×S permutation matrix modeling the indexing of the source entities,

F denotes a R×S relay input channel between the source entities and the at least one relaying entity,

Λ₂ denotes a diagonal matrix of weighting coefficients,

H denotes a N_{d}×R channel between the at least one relaying entity and the sink entities, N_{d} being the number of sink entities,

nᵣ denotes noise at a receiving end of the at least one relaying entity, and

n_{d} denotes noise at a receiving end of the sink entities.

Without being restricted to the details following in this section, the examples of the present invention may be summarized as follows:

Examples of the present invention propose relay-aware routing, in the sense that the relay entity may directly affect the routing decision (or suggest a routing decision to network), i.e. the decision from which entity it receives which signal (and/or to which entity it transmits the signal). For example, consider a case with two base stations, two UEs, and a MIMO relay. If the MIMO relay receives user 1 signal from base station 1 and user signal from base station 2, the effective MIMO-relay channel may have poor rank. However, if base station 2 transmits user 1 signal (while base station 1 transmits user 2 signal), then the system could concurrently support both users' signals on the same channel, thus doubling spectral efficiency. Here, MIMO amplify-forward relaying is considered as an exemplary implementation (alternatives being decode and forward relaying or estimate and forward relaying, for example, where the received signal is at least partially detected or decoded, recoded, remodulated, before transmission). It is to be noted that in a mesh network, also the receive entities could selected.

Examples of the present invention propose a controllable source (or sink) entity selection (indexing), aided by a MIMO-relay entity, to improve the network performance. When multiple simultaneous signals arrive at the relay entity on the same time-frequency slot and they have fixed sink entities, it is possible to improve the end-to-end performance via relay-aware or relay-aided source indexing/selection, e.g. determination to which source node or entity the signal streams should be directed to in the network.

It is considered, as an example, a downlink scenario, where two devices are receiving information from two different base stations (or access points, etc.). Stream (intended for device 1) arrives from BS 1, and stream 2 (intended for device 2) arrives simultaneously from BS 2. Assume that the relay entity has 4 antennas for reception and 4 for transmission. It is possible to fully orthogonalize the signals (so that neither device sees any interference from that intended for the other device) via the use of only 4 complex valued weighting coefficients at the relay (or with 4 single-antenna relays). Using these coefficients, the relay or relays can control both transmit power and beamforming at the relay entity. The examples of the present invention allow the relay entity to affect the source indexing, i.e. the source-sink pairs that are formed and thus affect routing decisions in the network. The source selection can be aided by computing the weighting coefficients for each feasible source-sink mapping and also acquiring a related performance measure (e.g. throughput or capacity estimate) for each such mapping (at source, sink, or at relay). This performance measure (or measures) can be transmitted to the routing unit for making the final decision. The relay can select the desired source entity indexing and signal this decision to the transmitting entities or to the network which can use of in routing. This solution requires less signaling capacity, as only the decisions are signaled, rather than the performance measures or the signal model or transfer function. In the presence of multiple relays, each relay can signal their respective decisions, or performance measures, of channel information and the network entity can compute the desired routing (and optimally also relay weighting) decisions. This is justified e.g. if there are multiple relays that have only a few antennas. If there is a single multi-antenna relay with full knowledge of all link gains and signal model parameters, then the decision made by the relay is feasible.

Formally, the examples of the present invention (e.g. applied to an AF-MIMO relay network) can be summarized using the following model, where S source entities, an R-antenna relay entity (or R single-antenna relays) and S sink entities are present.

In the examples of the present invention, each relay may multiply its respective received signal with an antenna/beam-specific complex weighting coefficient wᵣ, where the coefficient is optimized jointly with a relay input-output (source-sink) mapping. Relay weights computed for different (at least two) source-sink pairings lead to different performance for different pairs, and therefore, relay operations influence directly handover and routing decisions of the network. Determining the optimum pairing can be done e.g. in the relay entity (possibly with the aid of network and devices) or at a network (controller), with input from relay (or relays).

It is considered, as an example how to implement the invention, a particular relaying solution being an AF-MIMO relaying concept and imposing a permutation matrix on the signal model. Let II denote an S×S permutation matrix. This matrix models the different pairings for the relay entity. Imposing this matrix on a signal model leads to:

y=H·Λ₂·F·Π·x+H·Λ₂·nᵣ+n_{d} (5).

This affects the computation of the weighting matrix, which depends on the selected (computed) weighting matrix, i.e. is of the form

Λ₂=Λ₂(H,FΠ) (6)

or simply Λ₂=Λ₂(Π), highlighting the effect of the permutation matrix or source indexing, which modifies F into FΠ (or H into ΠH if sink is to be selected). In these cases, the mutual information is also affected by the presence of the permutation, and in case of source (permutation) selection,

α=½ log₂ det(I+PHΛ₂(Π)ΛFF⁺ΠΛ₂(Π)⁺H⁺Rₙₙ⁻¹) (7)

where the noise correlation matrix is

Rₙₙ=(σ_{d}²I+σᵣ²HΛ₂(Π)Λ₂(Π)⁺H⁺) (8)

Factor ½ in model (7) is due to two-hop relaying, used here for simplicity and not to restrict the invention to a case where half of the channel resources (e.g. time-frequency slots) are used by first and second hop, respectively.

### Implementation

The relay entity computes (if received from an external entity) the weighting matrix computed for different source-sink pairings. The relay can relay pilot signals of different feasible pairings through the relay and let the sinks determine their performance measures (e.g. SNR, CQI etc.) or the relay can compute them (or a related other measure with information available at relay node) using available information (on channels, noise power etc.). Note that the relay does not necessarily know all parameters of the signal model (e.g. noise power at destination), but it can nevertheless approximate the model.

Further, the method/apparatus can be used to determine or to select the indexing of the source entities or the relay entities, or both. For some services, the sink entity can be one of many (e.g. cellular uplink either base station can be selected), while for other the source entity can be any (e.g. cellular downlink). In a multi-hop mesh network, both may need to be optimized (regardless of where it is done).

The relay entity can change carrier frequency or multiple access scheme when transmitting the signal to the sink. Furthermore, the incoming signals or outgoing signals may use orthogonal multiple access schemes (then matrices H and F designate effective channels).

The relay input channel F need not necessarily use the same technology as the relay uplink channel H. One of them could be WLAN, while the other could be LTE, for example.

### Further Examples

For the purpose of the present invention as described herein above, it should be noted that

a circuitry may refer to at least one of, or hybrids of the following:
(a) to pure hardware circuit implementations (such as implementations purely in analog and/or digital circuitry), and
(b) to combinations of circuits and software (and/or firmware), such as (as applicable):
   (i) a combination of processor(s), or
   (ii) portions of processor(s)/software (including digital signal processor(s)), software and memory (or memories) that work together to cause an apparatus as defined hereinabove to perform various functions, and
(c) to circuits, such as (micro)processor(s) or a portion of (a) (micro)processor(s) that require software and/or firmware for operation even if the software or firmware is not physically present;

a processor may be any processing unit, such as CPU, arithmetic and logic unit (ALU), microprocessor unit (MPU), digital signal processor (DSP) etc., be it a single core processor, dual core processor or multi-core processor;

a program may be embodied by or on any computer program (product), computer readable medium, processor(s), memory (or memories), circuitry, circuits, random access memory (RAM), read-only memory (ROM) and/or data structure(s), be it e.g. as compiled/non-compiled program (source) code, executable object, (meta)file or the like;

an access technology may be any technology by means of which a user equipment can access an access network (or base station, respectively). Any present or future technology, such as WiMAX (Worldwide Interoperability for Microwave Access) or WLAN (Wireless Local area Network), BlueTooth, Infrared, and the like may be used; although the above technologies are mostly wireless access technologies, e.g. in different radio spectra, access technology in the sense of the present invention may also imply wirebound technologies, e.g. IP based access technologies like cable networks or fixed line.

a network may be any device, unit or means by which a station entity or other user equipment may connect to and/or utilize services offered by the access network; such services include, among others, data and/or (audio-) visual communication, data download etc.;

generally, the present invention may be applicable in those network/user equipment environments relying on a data packet based transmission scheme according to which data are transmitted in data packets and which are, for example, based on the internet protocol (IP). The present invention is, however, not limited thereto, and any other present or future IP or mobile IP (MIP) version, or, more generally, a protocol following similar principles as (M)IPv4/6, is also applicable;

a user equipment may be any device, unit or means by which a system user may experience services from an access network;

method steps likely to be implemented as software code portions and being run using a processor at a network element or terminal (as examples of devices, apparatuses and/or modules thereof, or as examples of entities including apparatuses, circuitries and/or modules therefore), are software code independent and can be specified using any known or future developed programming language as long as the functionality defined by the method steps is preserved;

generally, any method step is suitable to be implemented as software or by hardware without changing the idea of the invention in terms of the functionality implemented;

method steps and/or devices, units or means likely to be implemented as hardware components at the above-defined apparatuses, or any module(s)/circuitry(ies) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may alternatively be based on any security architecture capable e.g. of authentication, authorization, keying and/or traffic protection;

devices, units, circuitries or means (e.g. the above-defined apparatuses, or any one of their respective means) can be implemented as individual devices, units or means, but this does not exclude that they are implemented in a distributed fashion throughout the system, as long as the functionality of the device, unit circuitry or means is preserved;

an apparatus may be represented by a semiconductor chip, a chipset, a (hardware) module comprising such chip or chipset, or a circuitry; this, however, does not exclude the possibility that a functionality of an apparatus, module or circuitry, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

According to an example of the present invention, in a first aspect, this object is for example achieved by a method comprising:

indexing at least two source streams from at least one source entities and/or at least two sink streams to at least two sink entities; and

determining that at least one signal from the at least one source entity to the at least two sink entities is to be relayed based on a result of the indexing.

According to further refinements of the example of the present invention as defined under the above first aspect,

the indexing comprises forming of source-sink pairs based on the at least one source entity and the at least two sink entities;

the indexing comprises computing weighting coefficients for source-sink pairs, and evaluating performance measures for at least two source-sink pairs using the computed weighting coefficients;

the computing is based on available information such that the weighting coefficients producing the highest mutual information are selected;

the indexing comprises detecting that a weighting matrix comprising weighting coefficients is to be received;

the determining comprises multiplying the at least one signal to be relayed with the weighting coefficients;

the indexing is being used as an input for a network routing protocol, and the determining further comprises routing one of the at least two source streams and/or the at least two sink streams;

a transfer function y′ of at least one relaying entity with a transmission rank R has the form:

y′=H·Λ₂·F·II·x,

wherein:

x denotes a source signal x(s), s=1, . . . , S from S source entities,

Π denotes an S×S permutation matrix modeling the indexing of the source entities,

F denotes a R×S relay input channel between the source entities and the at least one relaying entity,

Λ₂ denotes a diagonal matrix of weighting coefficients, and

H denotes a N_{d}×R channel between the at least one relaying entity and the sink entities, N_{d} being the number of sink entities;

a function y of a network comprising S source entities, at least one relaying entity with a transmission rank R and N_{d} sink entities has the form:

y=H·Λ₂·F·Π·x+H·Λ₂·nᵣ+n_{d},

wherein:

x denotes a source signal x(s), s=1, . . . , S,

Π denotes an S×S permutation matrix modeling the indexing of the source entities,

F denotes a R×S relay input channel between the source entities and the at least one relaying entity,

Λ₂ denotes a diagonal matrix of weighting coefficients,

H denotes a N_{d}×R channel between the at least one relaying entity and the sink entities, N_{d} being the number of sink entities,

nᵣ denotes noise at a receiving end of the at least one relaying entity, and

n_{d} denotes noise at a receiving end of the sink entities;

the relay input channel F is based on a first access technology and the channel H is based on a second access technology different from the first access technology;

the at least one signal to be relayed is changed in terms of one of carrier frequency and multiple access scheme;

the at least one signal to be relayed is based on orthogonal multiple access scheme;

the sink entities is one selected from the sink entities;

the performance measure is one of a throughput, a capacity estimate, a signal-to-noise ratio and a channel quality indicator;

the available information is at least one of channel information, noise power, and pilot channels;

the first access technology is constituted by a wireless local area network;

the second access technology is constituted by long term evolution;

the routing comprises a handover of at least one user from a first base station to a second base station.

According to an example of the present invention, in a second aspect, this object is for example achieved by an apparatus comprising:

means for indexing at least two source streams from at least one source entity and/or at least two sink streams to at least two sink entities; and

means for determining that at least one signal from the at least one source entity to the at least two sink entities is to be relayed based on a result of the indexing.

According to further refinements of the example of the present invention as defined under the above second aspect,

the means for indexing comprises means for forming of source-sink pairs based on the at least one source entity and the at least two sink entities;

the means for indexing comprises means for computing weighting coefficients for source-sink pairs, and means for evaluating performance measures for at least two source-sink pairs using the computed weighting coefficients;

the means for computing is configured to compute based on available information such that the weighting coefficients producing the highest mutual information are selected;

the means for indexing comprises means for detecting that a weighting matrix comprising the weighting coefficients is to be received;

the means for determining comprises means for multiplying the at least one signal to be relayed with the weighting coefficients;

the means for indexing is configured to be used as an input for a network routing protocol, and the means for determining further comprises means for routing one of the at least two source streams and/or the at least two sink streams;

a transfer function y′ of at least one relaying entity with a transmission rank R has the form:

y′=H·Λ₂·F·Π·x,

wherein:

x denotes a source signal x(s), s=1, . . . , S from S source entities,

Π denotes an S×S permutation matrix modeling the indexing of the source entities,

F denotes a R×S relay input channel between the source entities and the at least one relaying entity,

Λ₂ denotes a diagonal matrix of weighting coefficients, and

H denotes a N_{d}×R channel between the at least one relaying entity and the sink entities, N_{d} being the number of sink entities;

the relay input channel F is based on a first access technology and the channel H is based on a second access technology different from the first access technology;

the at least one signal to be relayed is changed in terms of one of carrier frequency and multiple access scheme;

the at least one signal to be relayed is based on orthogonal multiple access scheme;

the sink entities is one selected from the sink entities;

the performance measure is one of a throughput, a capacity estimate, a signal-to-noise ratio and a channel quality indicator;

the available information is one of channel information, noise power and pilot channels;

the first access technology is constituted by a wireless local area network;

the second access technology is constituted by long term evolution;

the means for routing is configured to perform or control a handover of at least one user from a first base station to a second base station;

the apparatus is constituted by one relaying entity having a multi-antenna transceiving array;

the apparatus is constituted by at least two relaying entities each having a single transceiving antenna;

at least one, or more of means for indexing, means for determining, means for forming, means for computing, means for evaluating, means for multiplying, means for detecting and the apparatus is implemented as a chipset, module, subassembly or circuitry.

According to an example of the present invention, in a third aspect, this object is for example achieved by an apparatus comprising:

at least one processor; and

at least one memory including computer program code,

the at least one memory and computer program code being configured to, with the at least one processor, cause the apparatus at least to perform:

indexing at least two source streams from at least one source entity and/or at least two sink streams to at least two sink entities; and

determining that at least one signal from the at least one source entity to the at least two sink entities is to be relayed based on a result of the indexing.

According to further refinements of the example of the present invention as defined under the above third aspect, the at least one memory and computer program code are further configured to, with the at least one processor, cause the apparatus at least to perform:

the indexing comprising forming of source-sink pairs based on the at least one source entity and the at least two sink entities;

the indexing comprising computing weighting coefficients for source-sink pairs, and evaluating performance measures for at least two source-sink pairs using the computed weighting coefficients;

computing based on available information such that the weighting coefficients producing the highest mutual information are selected;

the indexing comprising detecting that a weighting matrix comprising the weighting coefficients is to be received;

the determining comprising multiplying the at least one signal to be relayed with the weighting coefficients;

the indexing being used as an input for a network routing protocol, and the determining further comprising routing one of the at least two source streams and/or the at least two sink streams;

a transfer function y′ of at least one relaying entity with a transmission rank R having the form:

y′=H·Λ₂·F·Π·x,

wherein:

x denotes a source signal x(s), s=1, . . . , S from S source entities,

Π denotes an S×S permutation matrix modeling the indexing of the source entities,

F denotes a R×S relay input channel between the source entities and the at least one relaying entity,

Λ₂ denotes a diagonal matrix of weighting coefficients, and

H denotes a N_{d}×R channel between the at least one relaying entity and the sink entities, N_{d} being the number of sink entities;

the relay input channel F being based on a first access technology and the channel H being based on a second access technology different from the first access technology;

the at least one signal to be relayed being changed in terms of one of carrier frequency and multiple access scheme;

the at least one signal to be relayed being based on orthogonal multiple access scheme;

the sink entities being one selected from the sink entities;

the performance measure being one of a throughput, a capacity estimate, a signal-to-noise ratio and a channel quality indicator;

the available information being one of channel information, noise power and pilot channels;

the first access technology being constituted by a wireless local area network;

the second access technology being constituted by long term evolution;

the routing being performed or controlling a handover of at least one user from a first base station to a second base station;

the apparatus being constituted by one relaying entity having a multi-antenna transceiving array;

the apparatus being constituted by at least two relaying entities each having a single transceiving antenna;

at least one, or more of indexing, determining, forming, computing, evaluating, multiplying, detecting, to the performing of which the apparatus is at least cased to, and the apparatus itself being implemented as a chipset, module, subassembly or circuitry.

According to an example of the present invention, in a fourth aspect, this object is for example achieved by a system comprising:
(a) S source entities;
(b) one relaying entity having transmission rank R according to the above second or third aspects,
   or
at least one relaying entity according to the above second or third aspects, the sum of transmission ranks of which equals to R and a network controller for controlling the at least one relaying entity; and
(c) N_{d} sink entities.

According to further refinements of the example of the present invention as defined under the above fourth aspect,

a function y of the system has the form:

y=H·Λ₂·F·Π·x+H·Λ₂·nᵣ+n_{d},

wherein:

x denotes a source signal x(s), s=1, . . . , S,

Π denotes an S×S permutation matrix modeling the indexing of the source entities,

F denotes a R×S relay input channel between the source entities and the at least one relaying entity,

Λ₂ denotes a diagonal matrix of weighting coefficients,

H denotes a N_{d}×R channel between the at least one relaying entity and the sink entities, N_{d} being the number of sink entities,

nᵣ denotes noise at a receiving end of the at least one relaying entity, and

n_{d} denotes noise at a receiving end of the sink entities.

According to an example of the present invention, in a fifth aspect, this object is for example achieved by a computer program product comprising code means for performing a method according to the above first aspect when run on a processing means, module or circuitry.

According to an example of the present invention, in a sixth aspect, this object is for example achieved by a computer program comprising computer program code being configured to, with least one processor, to cause an apparatus at least to perform:

indexing at least two source streams from at least one source entity and/or at least two sink streams to at least two sink entities; and

determining that at least one signal from the at least one source entity to the at least two sink entities is to be relayed based on a result of the indexing.

Although the present invention has been described herein before with reference to particular embodiments thereof, the present invention is not limited thereto and various modification can be made thereto.

1.-33. (canceled)

34. A method, comprising:
indexing at least two source streams from at least one source entities and/or at least two sink streams to at least two sink entities, wherein the indexing is being used as an input for a network routing protocol; and
determining that at least one signal from the at least one source entity to the at least two sink entities is to be relayed based on a result of the indexing, wherein the determining comprises routing one of the at least two source streams and/or the at least two sink streams.

35. The method according to claim 34, wherein the indexing comprises forming of source-sink pairs based on the at least one source entity and the at least two sink entities.

36. The method according to claim 34, wherein the indexing comprises:
computing weighting coefficients for source-sink pairs; and
evaluating performance measures for at least two source-sink pairs using the computed weighting coefficients.

37. The method according to claim 36, wherein the indexing further comprises detecting that a weighting matrix comprising weighting coefficients is to be received.

38. The method according to claim 36, wherein the determining comprises multiplying the at least one signal to be relayed with the weighting coefficients.

39. The method according to claim 34, wherein a transfer function y′ of at least one relaying entity with a transmission rank R has the form:
y′=H·Λ₂·F·Π·x,
wherein:
x denotes a source signal x(s), s=1, . . . , S from S source entities,
Π denotes an S×S permutation matrix modeling the indexing of the source entities,
F denotes a R×S relay input channel between the source entities and the at least one relaying entity,
Λ₂ denotes a diagonal matrix of weighting coefficients, and
H denotes a N_{d}×R channel between the at least one relaying entity and the sink entities, N_{d} being the number of sink entities.

40. The method according to claim 36, wherein the relay input channel F is based on a first access technology and the channel H is based on a second access technology different from the first access technology.

41. The method according to claim 34, wherein the at least one signal to be relayed is changed in terms of one of carrier frequency and multiple access scheme.

42. An apparatus, comprising:
at least one processor; and
at least one memory including computer program code, the at least one memory and the computer program code configured to, with the at least one processor, cause the apparatus to perform at least the following:
index at least two source streams from at least one source entities and/or at least two sink streams to at least two sink entities, wherein the indexing is being used as an input for a network routing protocol; and
determine that at least one signal from the at least one source entity to the at least two sink entities is to be relayed based on a result of the indexing, wherein the determining comprises routing one of the at least two source streams and/or the at least two sink streams.

43. The apparatus according to claim 42, wherein the indexing comprises forming of source-sink pairs based on the at least one source entity and the at least two sink entities.

44. The apparatus according to claim 42, wherein the indexing comprises:
computing weighting coefficients for source-sink pairs; and
evaluating performance measures for at least two source-sink pairs using the computed weighting coefficients.

45. The apparatus according to claim 44, wherein the indexing further comprises detecting that a weighting matrix comprising weighting coefficients is to be received.

46. The apparatus according to claim 44, wherein the determining comprises multiplying the at least one signal to be relayed with the weighting coefficients.

47. The apparatus according to claim 42, wherein a transfer function y′ of at least one relaying entity with a transmission rank A has the form:
y′=H·Π₂·F·Π·x,
wherein:
x denotes a source signal x(s), s=1, . . . , S from S source entities,
Π denotes an S×S permutation matrix modeling the indexing of the source entities,
F denotes a R×S relay input channel between the source entities and the at least one relaying entity,
Λ₂ denotes a diagonal matrix of weighting coefficients, and
H denotes a N_{d}×R channel between the at least one relaying entity and the sink entities, N_{d} being the number of sink entities.

48. The method according to claim 47, wherein the relay input channel F is based on a first access technology and the channel H is based on a second access technology different from the first access technology.

49. The apparatus according to claim 34, wherein the at least one signal to be relayed is changed in terms of one of carrier frequency and multiple access scheme.

50. A computer program product comprising a computer-readable medium bearing computer program code embodied therein for use with a computer, the computer program code comprising:
code for indexing at least two source streams from at least one source entities and/or at least two sink streams to at least two sink entities, wherein the indexing is being used as an input for a network routing protocol; and
code for determining that at least one signal from the at least one source entity to the at least two sink entities is to be relayed based on a result of the indexing, wherein the determining comprises routing one of the at least two source streams and/or the at least two sink streams.

51. The computer program product according to claim 50, wherein the indexing comprises forming of source-sink pairs based on the at least one source entity and the at least two sink entities.

52. The computer program product according to claim 50, wherein the indexing comprises:
computing weighting coefficients for source-sink pairs; and
evaluating performance measures for at least two source-sink pairs using the computed weighting coefficients.

53. The computer program product according to claim 52, wherein the determining comprises multiplying the at least one signal to be relayed with the weighting coefficients.
